(19) United States
(12) Patent Application Publication
(10) Pub. No.: US 2019/0236135 A1
(43) Pub. Date: Aug. 1, 2019

(54) CROSS-LINGUAL TEXT CLASSIFICATION

(71) Applicant: Accenture Global Solutions Limited, Dublin (IE)

(72) Inventor: Shashi Bhushan Tyamagondlu Nagabhushan, Dublin (IE)

(21) Appl. No.: 15/883,947

(22) Filed: Jan. 30, 2018

(51) Int. Cl. G06F 17/27; G06N 3/04; G06N 3/08

(52) U.S. Cl. CPC G06F 17/2785; G06N 3/08; G06N 3/04

(57) ABSTRACT

A device may be configured to obtain text from a document. The device may perform embedding to obtain a data structure indicating probabilities associated with characters included in the text and apply a first convolution to the data structure to obtain different representations of the characters included in the text. In addition, the device may apply parallel convolution to the different representations to obtain multiple sets of character representations, subsample the multiple sets of character representations, and pool the subsampled multiple sets of character representations into a merged data structure. The device may provide the merged data structure to a fully connected layer, of a convolutional neural network, to produce data representing features of the text; and provide the data representing features of the text to an inference layer, of the convolutional neural network, that provides data indicating a classification for the text.

### BACKGROUND

Text classification, also known as document classification, is a method of assigning one or more classifications, labels, or categories to a document or other body of text. Text may be classified in a variety of ways (e.g., according to subject, intent, type, and/or other attribute) and for a variety of reasons (e.g., to organize text, sort text, search text, or the like).

### SUMMARY

According to some implementations, a device may comprise: one or more memory devices; and one or more processors, communicatively connected to the one or more memory devices, to: obtain text from a document; perform embedding to obtain a data structure indicating probabilities associated with characters included in the text; apply a first convolution to the data structure to obtain different representations of the characters included in the text; apply parallel convolution to the different representations to obtain multiple sets of character representations; subsample the multiple sets of character representations; pool the subsampled multiple sets of character representations into a merged data structure; provide the merged data structure to a fully connected layer, of a convolutional neural network, to produce data representing features of the text; and provide the data representing features of the text to an inference layer, of the convolutional neural network, that provides data indicating a classification for the text.

According to some implementations, a method may comprise: obtaining, by a device, text from a training document; obtaining, by the device, data indicating an input classification associated with the training document; performing, by the device, embedding to obtain a character vector indicating probabilities associated with characters included in the text; applying, by the device, stacked convolution to the character vector to obtain different representations of the characters included in the text; applying, by the device, parallel convolution to the different representations to obtain multiple sets of character representations; subsampling, by the device, the multiple sets of character representations; pooling, by the device, the subsampled multiple sets of character representations to obtain a merged vector of features associated with the text; providing, by the device, the merged vector to a fully connected layer, of a convolutional neural network, to produce data representing features of the text; providing, by the device, the data representing features of the text to an inference layer, of the convolutional neural network, that provides data indicating one or more classifications for the text; and training, by the device, the convolutional neural network by backpropagation using stochastic gradient descent, the data indicating the input classification, and data indicating the one or more classifications.

According to some implementations, a non-transitory computer-readable medium may store instructions, the instructions comprising: one or more instructions that, when executed by one or more processors, cause the one or more processors to: obtain first text from a first document; perform embedding to obtain a character vector indicating probabilities associated with characters included in the first text; apply a first convolution to the character vector to obtain different representations of the characters included in the first text; apply parallel convolution to the different representations to obtain multiple sets of character representations, each performance of convolution, included in the parallel convolution, being different from other performances of convolution included in the parallel convolution; subsample the multiple sets of character representations; pool the multiple sets of character representations to obtain a merged data structure; provide the merged data structure to multiple fully connected layers, of a convolutional neural network, to produce data representing features of the first text; and provide the data representing features of the first text to an inference layer, of the convolutional neural network, that provides data indicating a first classification for the first document.

### BRIEF DESCRIPTION OF THE DRAWINGS

FIGS. 1A and 1B are diagrams of overviews of example implementations described herein;

FIG. 2 is a diagram of an example environment in which systems and/or methods, described herein, may be implemented;

FIG. 3 is a diagram of example components of one or more devices of FIG. 2;

FIG. 4 is a flow chart of an example process for cross-lingual text classification; and

FIG. 5 is a diagram of an example implementation relating to the example process shown in FIG. 4.

### DETAILED DESCRIPTION

The following detailed description of example implementations refers to the accompanying drawings. The same reference numbers in different drawings may identify the same or similar elements.

A variety of different text classification techniques may be capable of classifying text in a variety of ways. Example text classification techniques may include and/or otherwise make use of a variety of machine learning techniques, such as naïve Bayes classification, latent semantic indexing, support vector machines (SVM), K-nearest neighbors, artificial neural networks, or the like. Depending on a variety of factors, including the types of text, amount of text, variance of text, type of classification, and/or other factors, some text classification techniques perform better than others (e.g., in different situations). For example, classifying text by intent or subject, which often involves complex semantic analysis of text, may be difficult for some techniques, especially in situations where the type and amount of text are complex, such as cross-lingual text (texts in multiple languages).

Some implementations, described herein, may provide a text classification platform that uses a convolutional neural network to classify text in a manner designed to be agnostic regarding the natural language of the text. For example, a text classification platform may receive a document as input, provide the characters of the document as input to an input layer, use an embedding layer to provide a representation of each document using a data structure (e.g., a character vector), apply one or more stacked convolution layers to the data structures, apply parallel convolution layers with different filter sizes on the output of the stacked convolution layers, perform max over-time pooling for each of the parallel convolution layers, merge the output of the parallel convolution layers, provide the merged output to one or more fully connected layers to calculate probabilities associated with the classifications, and to provide the calculated probabilities to an inference layer to select one or more classifications for the document. In addition, the text classification platform may make use of backpropagation techniques to train the convolutional neural network in a manner designed to increase the accuracy of the convolutional neural network.

In this way, the text classification platform can classify text into one or more classifications (e.g., classes, categories, labels, or the like). The text classified may vary in a variety of ways, including by natural language, and the text classification platform does not need to train or otherwise make use of separate models or artificial neural networks for different languages. The text classification performed by the text classification platform may improve the efficiency of text classification, e.g., by performing text classification using fewer computing resources, such as processing resources, memory resources, or the like, than other text classification techniques. In addition, in some implementations, the text classification platform may enable the classification of hundreds, thousands, millions, etc., of documents from hundreds, thousands, millions, etc., of sources. Accordingly, the text classification platform may operate upon data items that cannot be processed objectively by a human actor.

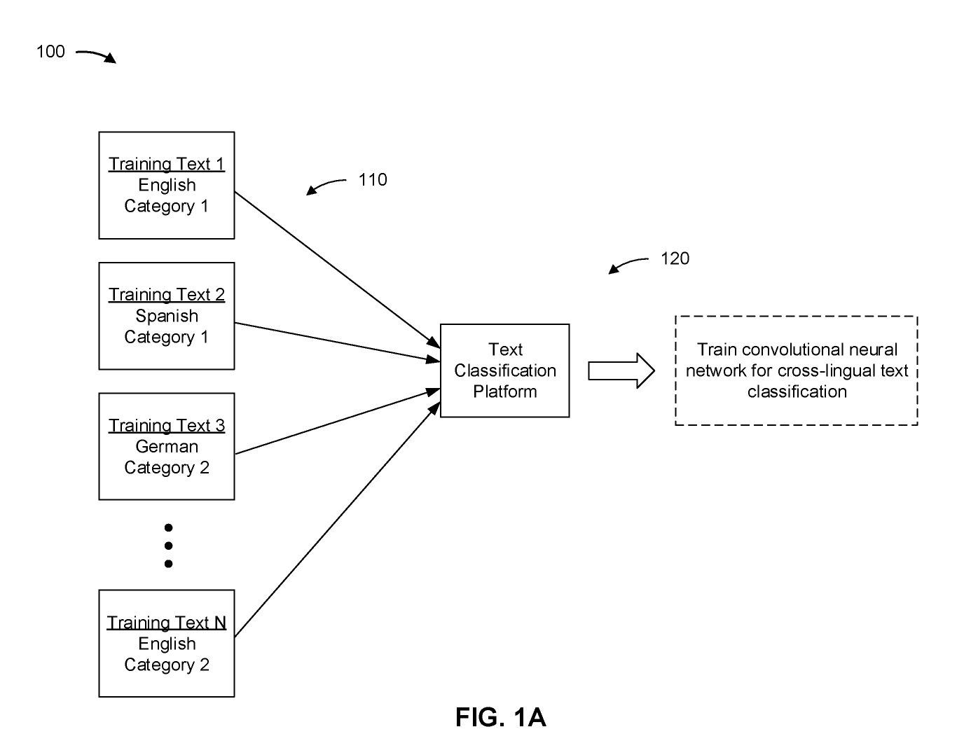

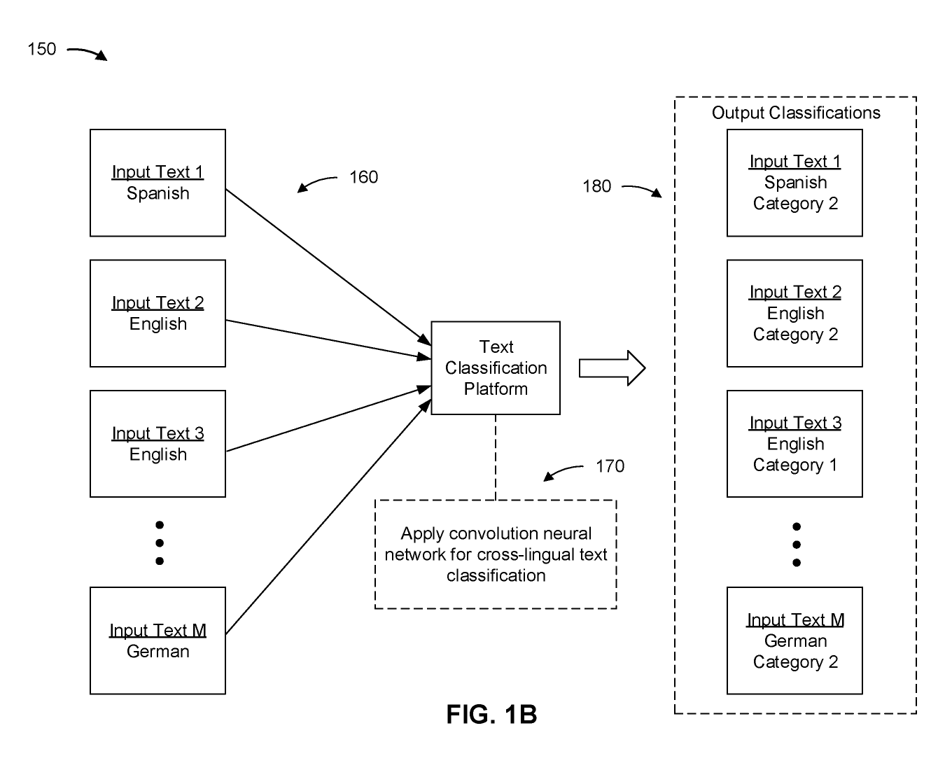

FIGS. 1A and 1B are diagrams of overviews of example implementations described herein. As shown in FIG. 1A, example implementation 100 includes a text classification platform. In some implementations, the text classification platform may include a cloud computing platform, one or more server devices, or the like. The text classification platform may be associated with an entity that wishes to classify documents for a variety of purposes (e.g., to classify micro-blog posts for user sentiment, to classify e-mails for intended purpose, to classify scholarly articles for subjects, or the like).

As shown in FIG. 1A, and by reference number 110, text classification platform receives training documents. The training documents may be in a variety of languages and be associated with a variety of classifications. By way of example, the training documents may be e-mail messages written in various languages and sent for a variety of purposes. For example, one e-mail may include training text 1, written in English, and belonging to a first classification; another e-mail may include training text 2, written in Spanish, and also belonging to the first classification; a third e-mail may include training text 3, written in German, and belonging to a second classification; and an example Nth e-mail may include training text N, written in English, and belonging to the second classification. The training text (e.g., included, in this example, in e-mail documents) may come from a variety of sources, including client devices, server devices, or the like.

As further shown in FIG. 1A, and by reference number 120, text classification platform trains a convolutional neural network to perform cross-lingual text classification. The process of training the convolutional neural network is described generally above and in further detail, below. In the example implementation 100, the convolutional neural network is trained using supervised machine learning (e.g., using previously provided classifications provided for the training documents), though the specific details of the machine learning techniques may vary (e.g., different labels and/or the like).

As shown in FIG. 1B, example implementation 150 includes a text classification platform (e.g., as trained in a manner similar to that shown and described above with reference to example implementation 100). As shown by reference number 160, the text classification platform receives input documents (e.g., including input text 1, 2, 3 . . . M). The input text may be in any language, e.g., as indicated by input text 1 being in Spanish, input texts 2 and 3 being in English, and input text M being in German. In addition, the input documents may be provided from any number of sources.

As further shown in FIG. 1B, and by reference number 170, the text classification platform applies a convolutional neural network trained for cross-lingual text classification, such as the convolutional neural network trained in example implementation 100. The application of the convolutional neural network may be performed in a manner similar to the training of the convolutional neural network, e.g., as described generally, above, and in further detail, below.

As further shown in FIG. 1B, and by reference number 180, the text classification platform produces, as output from the application of the convolutional neural network, classifications (e.g., categories, labels, or the like), for each of the input documents. In the example implementation 150, input text 1 has been classified as belonging to category 2, input text 2 has been classified as belonging to category 2, input text 3 has been classified as belonging to category 1, and input text M has been classified as belonging to category 2. The classifications may be associated with the input documents in a variety of ways and, in some implementations, the text classification platform may store, communicate, cause display of, or otherwise make use of data indicating the classifications associated with the input documents.

As noted above, the text classified may vary in a variety of ways, including the natural language of the text, and the text classification platform does not need to train or otherwise make use of separate models or artificial neural networks for different languages. The text classification performed by the text classification platform may improve the efficiency of text classification, e.g., by performing text classification using fewer computing resources, such as processing resources, memory resources, or the like, than other text classification techniques. In addition, in some implementations, the text classification platform may enable the classification of hundreds, thousands, millions, etc., of documents from hundreds, thousands, millions, etc., of sources.

As indicated above, FIGS. 1A and 1B are provided merely as examples. Other examples are possible and may differ from what was described with regard to FIGS. 1A and 1B.

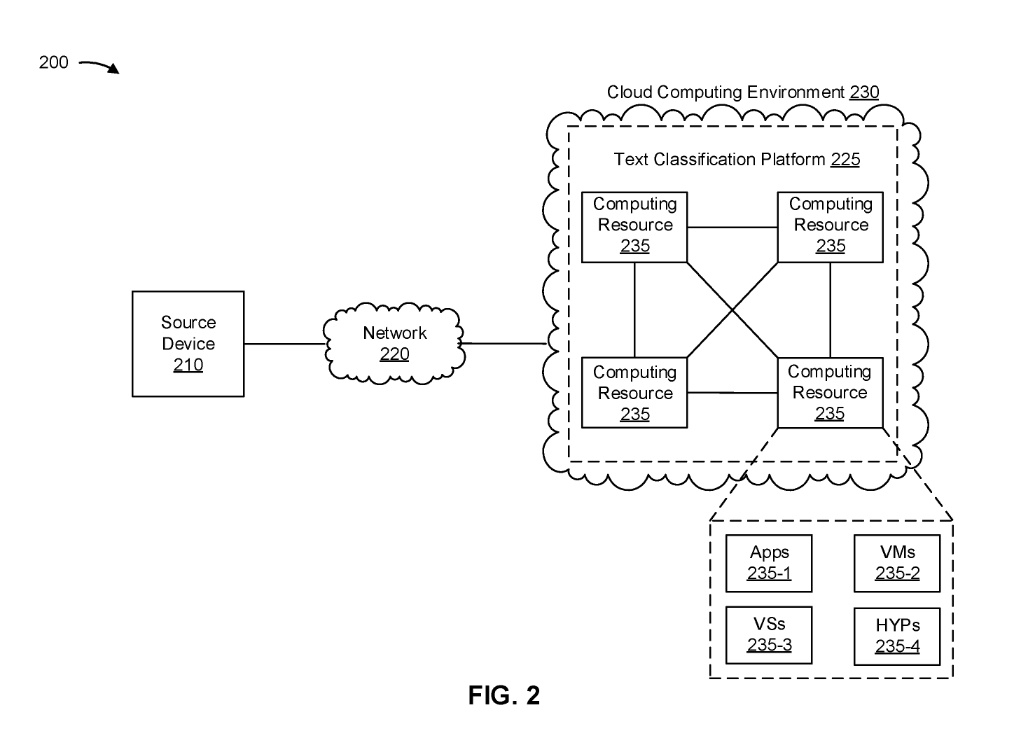

FIG. 2 is a diagram of an example environment 200 in which systems and/or methods, described herein, may be implemented. As shown in FIG. 2, environment 200 may include source device 210, network 220, and text classification platform 225 hosted within a cloud computing environment 230. Devices of environment 200 may interconnect via wired connections, wireless connections, or a combination of wired and wireless connections.

Source device 210 includes one or more devices capable of receiving, generating, storing, processing, and/or providing information associated with documents (e.g., data representing text). For example, source device 210 may include a communication and/or computing device, such as a mobile phone (e.g., a smart phone, a radiotelephone, etc.), a laptop computer, a tablet computer, a handheld computer, a server computer, a gaming device, a wearable communication device (e.g., a smart wristwatch, a pair of smart eyeglasses, etc.), or a similar type of device. In some implementations, source device 210 may include a system comprising multiple devices, such as a group of server devices associated with documents, a group of server devices associated with a database of documents, a group of server devices of a data center, or the like. Source device 210 may include one or more applications for providing documents to text classification platform 225, such as a web browsing application, e-mail management application, document management application, or the like.

Network 220 includes one or more wired and/or wireless networks. For example, network 220 may include a cellular network (e.g., a long-term evolution (LTE) network, a code division multiple access (CDMA) network, a 3G network, a 4G network, a 5G network, another type of next generation network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

Text classification platform 225 includes one or more devices capable of receiving, generating, storing, processing, and/or providing information associated with documents and classifications associated with documents. While the example environment 200 indicates that text classification platform 225 is implemented in a cloud computing environment 230, in some implementations, text classification platform 225 may be implemented by one or more other types of devices as well, such as a server computer outside of a cloud computing environment or the like. Text classification platform 225 is capable of using data, including documents, provided by one source device 210 or many source devices 210 to train and/or apply a convolutional neural network for classifying text included in documents.

Cloud computing environment 230 includes an environment that delivers computing as a service, whereby shared resources, services, etc. may be provided. Cloud computing environment 230 may provide computation, software, data access, storage, and/or other services that do not require end-user knowledge of a physical location and configuration of a system and/or a device that delivers the services. As shown, cloud computing environment 230 may include text classification platform 225 and computing resource 235.

Computing resource 235 includes one or more personal computers, workstation computers, server devices, or another type of computation and/or communication device. In some implementations, computing resource 235 may host text classification platform 225. The cloud resources may include compute instances executing in computing resource 235, storage devices provided in computing resource 235, data transfer devices provided by computing resource 235, etc. In some implementations, computing resource 235 may communicate with other computing resources 235 via wired connections, wireless connections, or a combination of wired and wireless connections.

As further shown in FIG. 2, computing resource 235 may include a group of cloud resources, such as one or more applications (“APPs”) 235-1, one or more virtual machines (“VMs”) 235-2, virtualized storage (“VSs”) 235-3, one or more hypervisors (“HYPs”) 235-4, or the like.

Application 235-1 includes one or more software applications that may be provided to or accessed by source device 210. Application 235-1 may eliminate a need to install and execute the software applications on source device 210. For example, application 235-1 may include software associated with text classification platform 225 and/or any other software capable of being provided via cloud computing environment 230. In some implementations, one application 235-1 may send/receive information to/from one or more other applications 235-1, via virtual machine 235-2.

Virtual machine 235-2 includes a software implementation of a machine (e.g., a computer) that executes programs like a physical machine. Virtual machine 235-2 may be either a system virtual machine or a process virtual machine, depending upon use and degree of correspondence to any real machine by virtual machine 235-2. A system virtual machine may provide a complete system platform that supports execution of a complete operating system (“OS”). A process virtual machine may execute a single program, and may support a single process. In some implementations, virtual machine 235-2 may execute on behalf of a user (e.g., using source device 210), and may manage infrastructure of cloud computing environment 230, such as data management, synchronization, or long-duration data transfers.

Virtualized storage 235-3 includes one or more storage systems and/or one or more devices that use virtualization techniques within the storage systems or devices of computing resource 235. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 235-4 provides hardware virtualization techniques that allow multiple operating systems (e.g., “guest operating systems”) to execute concurrently on a host computer, such as computing resource 235. Hypervisor 235-4 may present a virtual operating platform to the guest operating systems, and may manage the execution of the guest operating systems. Multiple instances of a variety of operating systems may share virtualized hardware resources.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

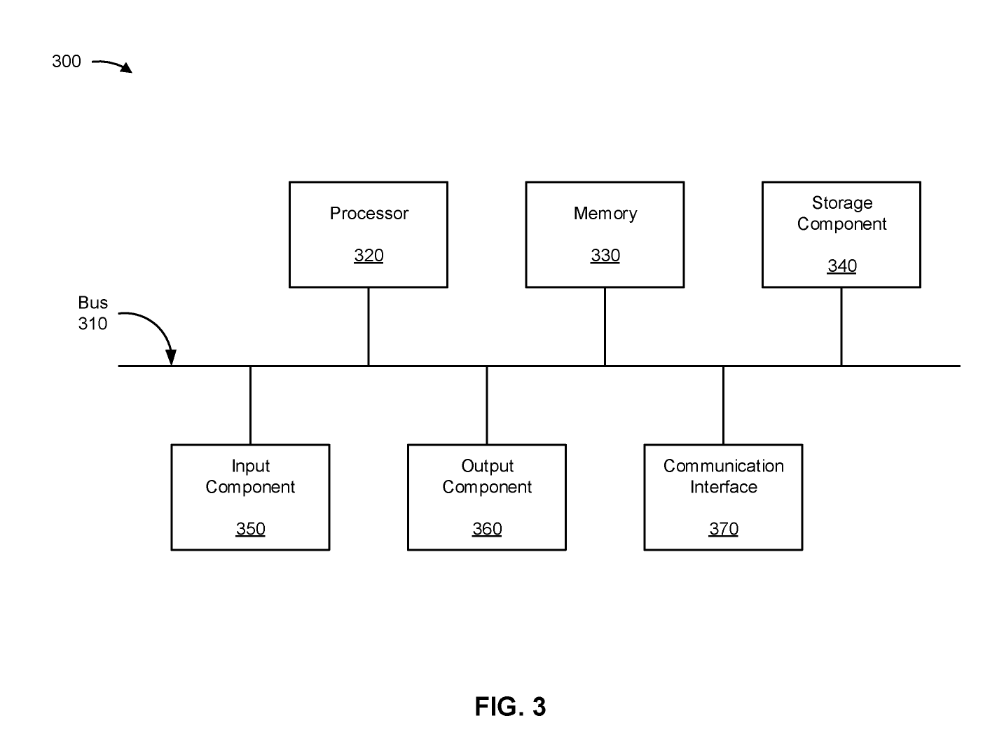

FIG. 3 is a diagram of example components of a device 300. Device 300 may correspond to source device 210 and/or text classification platform 225. In some implementations, source device 210 and/or text classification platform 225 may include one or more devices 300 and/or one or more components of device 300. As shown in FIG. 3, device 300 may include a bus 310, a processor 320, a memory 330, a storage component 340, an input component 350, an output component 360, and a communication interface 370.

Bus 310 includes a component that permits communication among the components of device 300. Processor 320 is implemented in hardware, firmware, or a combination of hardware and software. Processor 320 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 320 includes one or more processors capable of being programmed to perform a function. Memory 330 includes a random access memory (RAM), a read only memory (ROM), and/or another type of dynamic or static storage device (e.g., a flash memory, a magnetic memory, and/or an optical memory) that stores information and/or instructions for use by processor 320.

Storage component 340 stores information and/or software related to the operation and use of device 300. For example, storage component 340 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

Input component 350 includes a component that permits device 300 to receive information, such as via user input (e.g., a touch screen display, a keyboard, a keypad, a mouse, a button, a switch, and/or a microphone). Additionally, or alternatively, input component 350 may include a sensor for sensing information (e.g., a global positioning system (GPS) component, an accelerometer, a gyroscope, and/or an actuator). Output component 360 includes a component that provides output information from device 300 (e.g., a display, a speaker, and/or one or more light-emitting diodes (LEDs)).

Communication interface 370 includes a transceiver-like component (e.g., a transceiver and/or a separate receiver and transmitter) that enables device 300 to communicate with other devices, such as via a wired connection, a wireless connection, or a combination of wired and wireless connections. Communication interface 370 may permit device 300 to receive information from another device and/or provide information to another device. For example, communication interface 370 may include an Ethernet interface, an optical interface, a coaxial interface, an infrared interface, a radio frequency (RF) interface, a universal serial bus (USB) interface, a Wi-Fi interface, a cellular network interface, and/or the like.

Device 300 may perform one or more processes described herein. Device 300 may perform these processes based on processor 320 executing software instructions stored by a non-transitory computer-readable medium, such as memory 330 and/or storage component 340. A computer-readable medium is defined herein as a non-transitory memory device. A memory device includes memory space within a single physical storage device or memory space spread across multiple physical storage devices.

Software instructions may be read into memory 330 and/or storage component 340 from another computer-readable medium or from another device via communication interface 370. When executed, software instructions stored in memory 330 and/or storage component 340 may cause processor 320 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 3 are provided as an example. In practice, device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

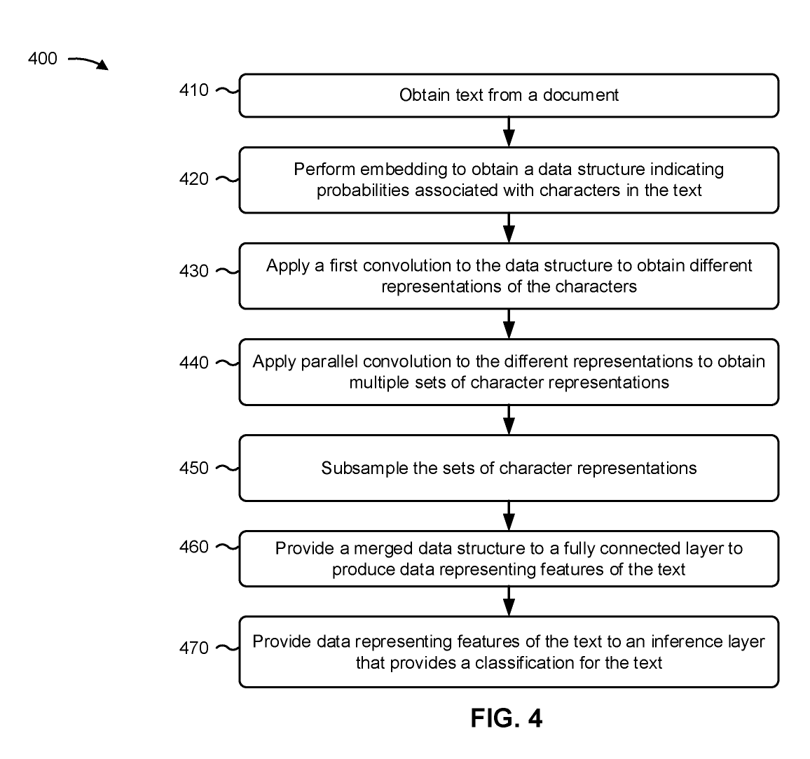

FIG. 4 is a flow chart of an example process 400 for cross-lingual text classification. In some implementations, one or more process blocks of FIG. 4 may be performed by text classification platform 225. In some implementations, one or more process blocks of FIG. 4 may be performed by another device or a group of devices separate from or including text classification platform 225, such as source device 210. In some implementations, process 400 may be used to train a convolutional neural network (e.g., using, as input, multiple training documents with predetermined classifications). In some implementations, process 400 may be used to apply a trained convolutional neural network (e.g., using, as input, documents for which a classification is to be produced).

As shown in FIG. 4, process 400 may include obtaining text from a document (block 410). For example, text classification platform 225 may receive data representing the text of a document. The text may be obtained in a variety of ways, including the use of an input stream, optical character recognition of an image that includes text, a text file, or the like. The text may be obtained from source device 210 or multiple source devices 210 (e.g., as micro-blog posts, e-mails, scholarly articles, or the like). Text classification platform 225 may read input text at a character level (e.g., rather than a sentence or word level).

In some implementations, text classification platform 225 may encode the text, e.g., in a manner designed to enable various actions to be performed on the encoded text. For example, the text may be encoded using character-level one-hot encoding to obtain a 1 by Z matrix (e.g., a one-hot vector) to distinguish each character in the text from each other character. In this situation, a one-hot vector may include 0's in all cells with the exception of a 1 in a cell used to uniquely identify the character. As noted above, using one-hot encoding on the input text may enable actions to be performed on the one-hot vectors, which uniquely identify each character included in the text, regardless of language, which may increase the efficiency of the text classification process and conserve processing resources relative to other text classification techniques.

In this way, text classification platform 225 may obtain text from a document, enabling text classification platform 225 to perform a variety of operations designed to classify the text.

As further shown in FIG. 4, process 400 may include performing embedding to obtain a data structure indicating probabilities associated with characters in the text (block 420). For example, text classification platform 225 may provide the text to an embedding layer of a convolutional neural network. The embedding layer produces a representation of the text in a data structure, such as a character vector.

In some implementations, text classification platform 225 uses the embedding layer to produce character vectors, which are representations of a vocabulary of characters (e.g., character vectors may indicate, for any character included in the text, a probability associated with each other character included in the text). This enables text classification platform 225 to produce a relatively dense, continuous, and distributed representation of the vocabulary, as opposed to a sparse representation that might be obtained by representing characters as one-hot encodings. The probabilities associated with the characters may indicate, for example, a measure of likelihood of a character occurring given the occurrence of another character, or the probability of other characters occurring given the character. Embedding layer may use a variety of techniques, such as skip-gram and/or continuous bag of words techniques, to produce the character vectors for the text of the document. Text classification platform 225 may use the embedding layer to produce character vectors in a manner designed to enable capturing information relevant to the text, such as syntactical and/or phonetic information, which may not be captured without the embedding layer.

In this way, text classification platform 225 may perform embedding to obtain a data structure indicating probabilities associated with characters in the text, enabling text classification platform 225 to perform convolution on the character vectors.

As further shown in FIG. 4, process 400 may include applying a first convolution to the data structure to obtain different representations of characters (block 430). For example, text classification platform 225 may perform textual convolution on the character vectors to obtain representations relevant to the text (e.g., the hidden representations related to sequences of characters). Text classification platform 225 may perform convolution, for example, by using a sliding window to analyze and learn hidden representations indicated by the sequence of character vectors.

By way of example, text classification platform 225 may perform convolution using a sliding window of 7 characters (though a window of additional or fewer characters could be used). The length of the sliding window may be predetermined or, in some implementations, vary as part of backpropagation and convolutional neural network training, described in further detail below. The convolution may be designed to identify 256 representations relevant to the text (though additional or fewer representations could be identified). In this situation, text classification platform 225 may produce, as output from the first convolution, 256 different character representations relevant to the text. For example, the character representations may include representations regarding the meaning of “-ing” or “-es” at the end of a string of characters, the meaning of “pre-” or “in-” at the beginning of a sequence of characters, or the like.

In some implementations, text classification platform 225 may perform stacked convolution. By stacking convolution layers of the convolutional neural network, text classification platform 225 may determine other representations relevant to the text. For example, text classification platform 225 may provide, to a second convolution layer, the output from the first convolution layer (e.g., in the example above, the 256 representations relevant to the text may be provided as input to a second convolution layer). In this situation, the second convolution layer produces representations relevant to the representations produced by the first convolution layer. The second convolution layer may use the same convolution parameters (e.g., sliding window of 7 to produce 256 representations) or different convolution parameters.

The representations obtained from the first convolution layer (or from stacked convolution layers in a situation where multiple convolution layers are applied) may provide a resulting vector that indicates syntactic, semantic, phonetic, and/or morphological features of the text. These features may be obtained, for example, as a result of providing the convolutional layer(s) with the character vectors in the sequence of occurrence.

In this way, text classification platform 225 may apply a first convolution to the data structure to obtain different representations of characters, enabling further convolution operations to be applied to the different representations of characters.

As further shown in FIG. 4, process 400 may include applying parallel convolution to the different representations to obtain multiple character representations (block 440). For example, text classification platform 225 may perform multiple different types of convolution on the output provided by the first convolution (e.g., the representations produced by the first convolution). The parallel convolution may result in various representations of characters being provided as output from the parallel convolution.

In some implementations, each convolution operation included in parallel convolution may be similar to the first convolution, where a sliding window is used to learn representations relevant to the characters. In this situation, each of the parallel convolutions are different, and are performed on the output of the first convolution. By way of example, text classification platform 225 may perform parallel convolution by performing multiple convolution operations, e.g., one with a sliding window of 4 characters, another with a sliding window of 5 characters, and another with a sliding window of 6 characters. As with the first convolution operation, the sliding window used by text classification platform 225 for parallel convolution may differ. Additionally, or alternatively, the number of relevant representations produced as output may differ, e.g., each different parallel convolution operation may provide the same or a different number of representations, such as 256 representations, 512 representations, or the like. In some implementations, one or more of the parallel convolution operations may include subsampling, or pooling, such as max over-time pooling, which is described in further detail, below.

In this way, text classification platform 225 may apply parallel convolution to the different character representations to obtain multiple sets of character representations, enabling text classification platform 225 to perform subsampling on the multiple sets of character representations and to produce a merged data structure that includes character representations relevant to the text.

As further shown in FIG. 4, process 400 may include subsampling the multiple character representations (block 450). For example, text classification platform 225 may subsample the sets of character representations (e.g., obtained from the output of parallel convolution). Subsampling is designed to down-sample the sets of character representations to reduce the dimensionality of the data, e.g., to prevent over-fitting by the convolutional neural network.

In some implementations, text classification platform 225 may use max over-time pooling to subsample the sets of character representations. For example, each set of character representations may be subsampled using a sliding window to analyze and reduce the dimensionality of the character representations. Other forms of subsampling (e.g., stochastic pooling, weighted subsampling, or the like) may also be used by text classification platform 225 to reduce the amount of character representations to be used for classification. In some implementations, the output of the subsampling may be a reduced size version (e.g., subsampled version) of the set of character representations, which may be reduced to a predetermined size for further processing.

In this way, text classification platform 225 may subsample the multiple character representations, enabling text classification platform 225 to merge the subsampled character representations into a merged data structure (e.g., in a pooling layer), and to use a fully connected layer on the subsampled and merged data structure. The merged data structure may, in some implementations, be a merged vector of features associated with the text. In some implementations, the merged data structure may be obtained by concatenating vectors obtained as a result of parallel convolution and subsampling.

As further shown in FIG. 4, process 400 may include providing the merged data structure to a fully connected layer to produce data representing features of the text (block 460). For example, text classification platform 225 may provide the merged data structure to a fully connected layer, of the convolutional neural network, that is capable of producing data representing features of text that may be useful for classifying the text. In some implementations, text classification platform 225 may use multiple fully connected layers applied serially (e.g., the output from one fully connected layer being used as input for a subsequent fully connected layer). The output from the fully connected layer(s) may be used by an inference layer, of the convolutional neural network, to classify the text.

Application of each fully connected layer includes the use of an activation function (e.g., Rectified Linear Unit (ReLU), Sigmoid, tan h, or the like) designed to introduce non-linearity, in a manner designed to enable the convolutional neural network to learn non-linear representations in the data representing features of the text. By way of example, text classification platform 225 may apply two fully connected layers using ReLU activation, resulting in a non-linear function representing a variety of features of the text. In some implementations, the number of features provided as output from each fully connected layer may vary (e.g., 512 features of the text from the first fully connected layer, and 256 features of the text from the second fully connected layer, or the like), and in some implementations the number of features may be the same for each of the fully connected layers.

In some implementations, text classification platform 225 may apply a dropout operation to one or more of the fully connected layers, e.g., in a manner designed to avoid over-fitting. Dropout may be applied, for example, on a random or non-random basis, such as dropping 50% of the features from the merged data structure. In some implementations, when multiple fully connected layers are used, dropout may be applied for one or more of the fully connected layers (e.g., after each application of a fully connected layer, after every other application of a fully connected layer, once after all applications of the fully connected layers, or the like). By way of example, text classification platform 225 may provide the merged data structure to two fully connected layers, each with 50% dropout, the first fully connected layer being configured to provide 512 features of the text and the second fully connected layer being configured to use the output of the first fully connected layer to provide 256 features of the text.

In this way, text classification platform 225 may provide the merged data structure to a fully connected layer to produce data representing features of the text, enabling text classification platform 225 to make use of an inference layer, of the convolutional neural network, to classify the text of the document.

As further shown in FIG. 4, process 400 may include providing data representing features of the text to an inference layer that provides a classification for the text (block 470). For example, text classification platform 225 may provide the features output from the fully connected layer(s) to an inference layer that uses the features to determine one or more classifications to be associated with the text.

In some implementations, the inference layer determines the probability of distribution over the potential classifications. The probabilities may be used to classify the text of the document. For example, text classification platform 225 may use a threshold probability to determine that probabilities meeting a particular threshold for a given classification, or label, may be associated with the text of the document. In some implementations, text classification platform 225 may use a fully connected Softmax layer to calculate the probability distribution over the classifications. Softmax uses a vector of arbitrary real-valued scores (e.g., derived from the data provided by the fully connected layers applied at block 460) and produces a vector of values between 0 and 1, the sum of which are 1.

In some implementations, text classification platform 225 uses backpropagation to train the convolutional neural network. Backpropagation enables updating various parameters of the convolutional neural network, as well as the features and values associated with the features used to classify text. For example, text classification platform 225 may use stochastic gradient descent to iteratively adjust the convolutional neural network. Using backpropagation may result in a convolutional neural network training process similar to the following: initializing parameters of the convolutional neural network layers and weights associated with features, e.g., using random values; go through the convolutional neural network process described above, e.g., with respect to blocks 410-470; calculate an error in the output, e.g., using the probabilities output at block 470 and the expected probability provided with the training documents (the predetermined classifications); and using backpropagation to calculate gradients of the error with respect to the weights associated with the features of the text and using gradient descent to update the parameters of the convolutional neural network layers and weights associated with the features, e.g., in a manner designed to minimize the output error; and iteratively repeat the foregoing process using training documents provided with predetermined classifications.

Text classification platform 225 may use the foregoing forward propagation and backpropagation techniques to train the convolutional neural network (e.g., tuning the parameters and weights associated with the features), enabling the convolutional neural network to be applied to new text of new documents (e.g., text for which a classification has not been predetermined). When applying the convolutional neural network to a new document, backpropagation is not needed. In some implementations, the convolutional neural network may be retrained, or updated, using new training documents (or a combination of new training documents and preexisting training documents), which may include documents that text classification platform 225 previously classified (e.g., in situations where the classifications were manually confirmed or updated).

In this way, text classification platform 225 may provide data representing features of the text to an inference layer that provides a classification for the text, enabling text classification platform 225 to both train and apply the convolutional neural network to classify text.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

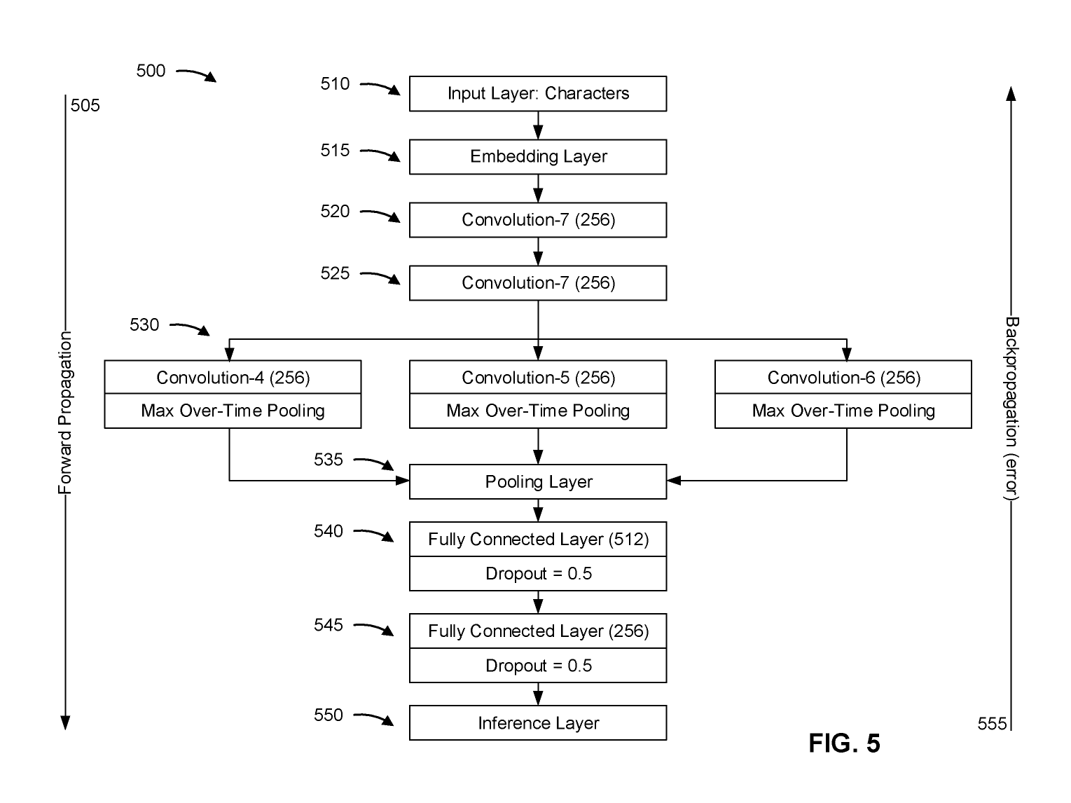

FIG. 5 is a diagram of an example implementation 500 relating to the example process shown in FIG. 4. FIG. 5 shows an example cross-lingual text classification process that may be implemented, for example, by text classification platform 225. The example implementation 500 illustrates both the application of the convolutional neural network (e.g., forward propagation 505) and training of the convolutional neural network (e.g., iterative application of forward propagation 505 and backpropagation 555).

As shown by reference number 510, the convolutional neural network includes an input layer that receives characters as input, such as the characters included in an e-mail or other document. As shown by reference number 515, the convolutional neural network includes an embedding layer that performs embedding on the input characters or representations of the characters in a situation where characters are encoded. The embedding layer may produce, for example, character vectors indicating a measure of probability that a character occurs, given the occurrence of another character.

As shown by reference numbers 520 and 525, the convolutional neural network includes two convolution layers, or stages. The two convolution layers operate upon the character embedding output (e.g., the character vectors), using sliding windows of 7 characters to obtain 256 features associated with the text. In the example implementation 500, the convolution layers operate serially, such that the output of the first convolution layer (e.g., first convolution neural network stage) is used as input for the second convolution layer (e.g., second convolution neural network stage).

As shown by reference number 530, the convolutional neural network includes a parallel convolution layer that, in the example implementation 500, provides three separate convolution layers performed on the output from the previous convolution layer. The parallel convolution layers each produce 256 features associated with the text while using, respectively, sliding windows of length 4, 5, and 6. While described as being performed in parallel, the parallel convolutions need not actually be executed in parallel, e.g., the parallel convolutions may be separately executed on the same input data. As shown in the example implementation 500, each of the parallel convolutions may have a corresponding subsampling layer to separately pool the features from each of the parallel convolutions. As shown by reference number 535, the convolutional neural network includes a pooling layer to pool together the output from the parallel convolution layer. The pooling layer may include subsampling, e.g., in a manner designed to drop features provided by the parallel convolution layer and avoid over fitting of the convolutional neural network.

As shown by reference numbers 540 and 545, the convolutional neural network includes two fully connected layers with 0.5 dropout, indicating that half of the features produced by each layer are dropped at random (e.g., half of the 512 produced by the first fully connected layer and half of the 256 produced by the second fully connected layer).

As shown by reference number 550, the convolutional neural network includes an inference layer to classify the text (e.g., associating classifications, categories, labels, or the like) using the features and weights provided by the fully connected layers. In situations where the convolutional neural network was previously trained, the classifications may be provided as output (e.g., to a separate device, such as source device 210, a storage device, or another device). The classifications may be used to indicate a classification, category, label, or the like, associated with the document from which the text came. The classifications may be used for a variety of purposes, including text categorization, indexing, sorting, analytics, or the like. In situations where the convolutional neural network is being trained, calculation of error and backpropagation 555 may be used to iteratively repeat the process and tune the parameters and weights associated with features accordingly.

As indicated above, FIG. 5 is provided merely as an example. Other examples are possible and may differ from what was described with regard to FIG. 5.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component is intended to be broadly construed as hardware, firmware, and/or a combination of hardware and software.

Some implementations are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, or the like.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware can be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. As used herein, the term “or the like” is intended to be inclusive (e.g., as in “and/or the like”), unless explicitly stated otherwise. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A device, comprising:
one or more memory devices; and
one or more processors, communicatively connected to the one or more memory devices, to:
obtain text from a document;
perform embedding to obtain a data structure indicating probabilities associated with characters included in the text;
apply a first convolution to the data structure to obtain different representations of the characters included in the text;
apply parallel convolution to the different representations to obtain multiple sets of character representations;
subsample the multiple sets of character representations;
pool the subsampled multiple sets of character representations into a merged data structure;
provide the merged data structure to a fully connected layer, of a convolutional neural network, to produce data representing features of the text; and
provide the data representing features of the text to an inference layer, of the convolutional neural network, that provides data indicating a classification for the text.

2. The device of claim 1, where the one or more processors are further to:
perform backpropagation using stochastic gradient descent and the data indicating the classification for the text.

3. The device of claim 1, where the one or more processors are further to:
encode the text, prior to performing the embedding, using one-hot encoding.

4. The device of claim 1, where the data structure includes at least one character vector.

5. The device of claim 1, where the one or more processors, when subsampling the multiple sets of character representations to obtain the merged data structure, are further to:
concatenate the multiple sets of character representations into a concatenated vector; and
perform max over-time pooling on the concatenated vector.

6. The device of claim 1, where the fully connected layer uses Rectified Linear Unit activation.

7. The device of claim 1, where the first convolution comprises a first convolution neural network stage and a second convolution neural network stage, the second convolution neural network stage being subsequent to the first convolution neural network stage.

8. The device of claim 1, where the first convolution neural network stage is applied to a group of data structures.

9. The device of claim 1, where the first convolution neural network stage is applied to a group of seven data structures.

10. The device of claim 1, where the parallel convolution comprises:
a first convolution neural network stage,
a second convolution neural network stage, and
a third convolution neural network stage,
the first convolution neural network stage and the second convolution neural network stage and the third convolution neural network stage being in parallel.

11. The device of claim 10, where the first convolution neural network stage is applied to a group of four data structures.

12. The device of claim 10, where the second convolution neural network stage is applied to a group of five data structures.

13. The device of claim 10, where the third convolution neural network stage is applied to a group of six data structures.

14. A method, comprising:
obtaining, by a device, text from a training document;
obtaining, by the device, data indicating an input classification associated with the training document;
performing, by the device, embedding to obtain a character vector indicating probabilities associated with characters included in the text;
applying, by the device, stacked convolution to the character vector to obtain different representations of the characters included in the text;
applying, by the device, parallel convolution to the different representations to obtain multiple sets of character representations;
sub sampling, by the device, the multiple sets of character representations;
pooling, by the device, the subsampled multiple sets of character representations to obtain a merged vector of features associated with the text;
providing, by the device, the merged vector to a fully connected layer, of a convolutional neural network, to produce data representing features of the text;
providing, by the device, the data representing features of the text to an inference layer, of the convolutional neural network, that provides data indicating one or more classifications for the text; and
training, by the device, the convolutional neural network by backpropagation using stochastic gradient descent, the data indicating the input classification, and data indicating the one or more classifications.

15. The method of claim 14, where applying the stacked convolution to the character vector to obtain different representations of the characters included in the text comprises:
for each convolution layer of the stacked convolution, using a sliding window of characters to produce a plurality of different representations of the characters included in the text.

16. The method of claim 14, where applying the parallel convolution to the different representations to obtain multiple sets of character representations comprises:
performing convolution using a sliding window of X,
where X is an integer;
performing convolution using a sliding window of X+1; and
performing convolution using a sliding window of X+2.

17. The method of claim 14, further comprising:
training the convolutional neural network using multiple training documents as input,
the multiple training documents including a first document having text in a first natural language and a second document having text in a second natural language,
the second natural language being different from the first natural language.

18. A non-transitory computer-readable medium storing instructions, the instructions comprising:
one or more instructions that, when executed by one or more processors, cause the one or more processors to:
obtain first text from a first document;
perform embedding to obtain a character vector indicating probabilities associated with characters included in the first text;
apply a first convolution to the character vector to obtain different representations of the characters included in the first text;
apply parallel convolution to the different representations to obtain multiple sets of character representations,
each performance of convolution, included in the parallel convolution, being different from other performances of convolution included in the parallel convolution;
subsample the multiple sets of character representations;
pool the multiple sets of character representations to obtain a merged data structure;
provide the merged data structure to multiple fully connected layers, of a convolutional neural network, to produce data representing features of the first text; and
provide the data representing features of the first text to an inference layer, of the convolutional neural network, that provides data indicating a first classification for the first document.

19. The non-transitory computer-readable medium of claim 18, where the one or more instructions, when executed by the one or more processors, further cause the one or more processors to:
obtain second text from a second document,
the second text being associated with a second natural language that is different from a first natural language associated with the first document;
perform embedding to obtain a second character vector indicating probabilities associated with characters included in the second text;
apply the first convolution to the second character vector to obtain different representations of the characters included in the second text;
apply the parallel convolution to the different representations to obtain multiple sets of second character representations,
subsample the multiple sets of second character representations;
pool the multiple sets of second character representations to obtain a second merged data structure;
provide the second merged data structure to multiple fully connected layers, of the convolutional neural network, to produce data representing features of the second text; and
provide the data representing features of the second text to the inference layer that provides data indicating a second classification for the second document.

20. The non-transitory computer-readable medium of claim 18, where the fully connected layers each includes a dropout operation to randomly drop portions of the data representing features of the first text.
